(19) United States
(12) Patent Application Publication
(10) Pub. No.: US 2010/0001151 A1
(43) Pub. Date: Jan. 7, 2010

(54) FRICTIONAL DASH MOUNT FOR A GLOBAL POSITIONAL SYSTEM

(76) Inventors: Alan J. Wheatley, Draper, UT (US); Bryce Craig, Alpine, UT (US)

Correspondence Address: THORPE NORTH & WESTERN, LLP., P.O. Box 1219, SANDY, UT, 84091-1219, US

(21) Appl. No.: 12/545,248

(22) Filed: Aug. 21, 2009

Related U.S. Application Data
(63) Continuation-in-part of application No. 12/205,059, filed on Sep. 5, 2008.
Application No. 12/205,059 is a continuation of application No. 11/264,669, filed on Oct. 31, 2005.
Application No. 11/264,669 is a continuation-in-part of application No. 11/021,560, filed on Dec. 22, 2004, now Pat. No. 7,252,867.
Application No. 11/021,560 is a continuation-in-part of application No. 10/684,008, filed on Oct. 10, 2003, now Pat. No. 7,125,602.
Application No. 10/684,008 is a division of application No. 10/209,948, filed on Jul. 30, 2002, now Pat. No. 6,673,409.
(60) Provisional application No. 60/308,955, filed on Jul. 31, 2001.
(60) Provisional application No. 60/344,571, filed on Dec. 28, 2001.

(51) Int. Cl. F16M 13/00; G09F 11/00; A47B 96/06; F16B 47/00

(52) U.S. Cl. 248/206.2; 248/346.01; 248/346.4; 40/1; 248/205.1

(57) ABSTRACT

A frictional holding device in combination with a dashboard or console of a vehicle and receives and secures a global positioning system thereon. The combination includes a dashboard or console of a vehicle. A pad has different top and bottom surfaces. The bottom surface is disposed on and frictionally clings to the dashboard or console of the vehicle. A global positioning system is removably coupled to the pad.

### PRIORITY CLAIM

This is a continuation-in-part of U.S. patent application Ser. No. 12/205,059, filed on Sep. 5, 2008; which is a continuation of U.S. patent application Ser. No. 11/264,669, filed Oct. 31, 2005; which is a continuation-in-part of U.S. Pat. No. 7,252,867, filed Dec. 22, 2004; which is a continuation-in-part of U.S. Pat. No. 7,125,602, filed Oct. 10, 2003; which is a divisional of U.S. Pat. No. 6,673,409, filed Jul. 30, 2002; which claims benefit of U.S. Provisional Patent Application Nos. 60/308,955, filed Jul. 31, 2001, and 60/344,571, filed Dec. 28, 2001; which are all hereby incorporated herein by reference in their entirety and for all purposes.

### BACKGROUND

1. Field of the Invention

The present invention relates generally to a frictional holding pad for securing a global positioning system (GPS) with respect to a vehicle surface.

2. Related Art

While some vehicles are provided with built-in GPS navigation systems, many vehicles are not, and after-market GPS navigation systems are available for use in such vehicles. The GPS navigation systems are often provided with a mount so hold the system, which has a viewing screen, in a suitable position for viewing while driving. Various mounting systems have been proposed, including a suction cup that holds by suction to the windshield or dash. In some locals it is illegal to mount object to the windshield. In addition, such mounting can interfere with normal vision through the windshield. It is also possible to mount the suction cup on the vehicle dashboard or consol, but such surfaces are often contoured or provided with functional and decorative items that interfere with the operation of the suction cup. An adhesive plate is also sometimes provided that can be adhesively applied to the dash, and that can receive the suction cup. It may, however, be undesirable to us an adhesive on the dashboard as such adhesive can leave a residue or remove dash covering. Another option is a device that holds a plate in place by use of several weighted lobes. Such devices can be bulky and unsightly.

### SUMMARY OF THE INVENTION

It has been recognized that it would be advantageous to develop a system and method for removably securing a GPS device with respect to the dashboard or console of a vehicle.

The invention provides a frictional holding device in combination with a dashboard or console of a vehicle and receives and secures a global positioning system thereon. The combination includes a dashboard or console of a vehicle. A pad has different top and bottom surfaces. The bottom surface is disposed on and frictionally clings to the dashboard or console of the vehicle. A global positioning system is removably coupled to the pad.

In addition, the invention provides a frictional holding device in combination with a dashboard or console of a vehicle and receives and secures a global positioning system thereon. The combination includes a dashboard or console of a vehicle. A flexible pad has different top and bottom surfaces. The bottom surface is disposed on and frictionally clings to the dashboard or console of the vehicle. At least a substantial portion of the top surface is a contoured top surface with a plurality of protrusions, a plurality of indentations, or both. A rigid plate is affixed to the flexible pad with an upper surface of the plate exposed with respect to the flexible pad. An arm extends from the rigid plate. A global positioning system is coupled to the arm and removably disposed over the top surface of the pad.

Furthermore, the invention provides a method for releasably securing a global positioning system on a dashboard or console of a vehicle without marring or altering the dashboard or console of the vehicle, comprising: placing a frictional holding pad on the dashboard or console of the vehicle with a bottom surface of the frictional holding pad contacting and frictionally clinging to the dashboard or console of the vehicle without marring or altering the dashboard or console of the vehicle; securing a global positioning system over a contoured top surface of the frictional holding pad; removing the global positioning system from over the frictional holding pad while the frictional holding pad remains on the dashboard or console of the vehicle; and removing the frictional holding pad from the dashboard or console of the vehicle without marring or altering the dashboard or console of the vehicle.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a frictional holding device in accordance with an embodiment of the present invention securing a GPS device to a dashboard or console of a vehicle;

FIG. 2 is top view of the frictional holding pad of FIG. 1;

FIG. 3 is a partial cross-sectional view of the frictional holding pad of FIG. 1, taken along line 3-3 of FIG. 2;

FIG. 4a is a bottom view of a plate of the frictional holding pad of FIG. 1; and

FIGS. 4b-d are partial cross-sectional views of the plate of FIG. 4a, taken alond lines 4b-4b, 4c-4c and 4d-4d of FIG. 4a, respectively.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

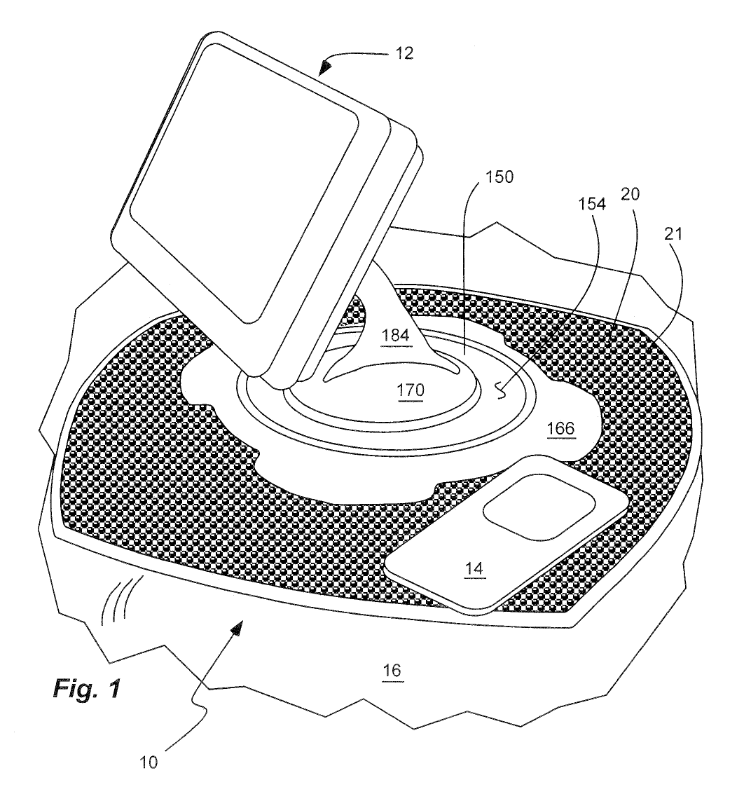

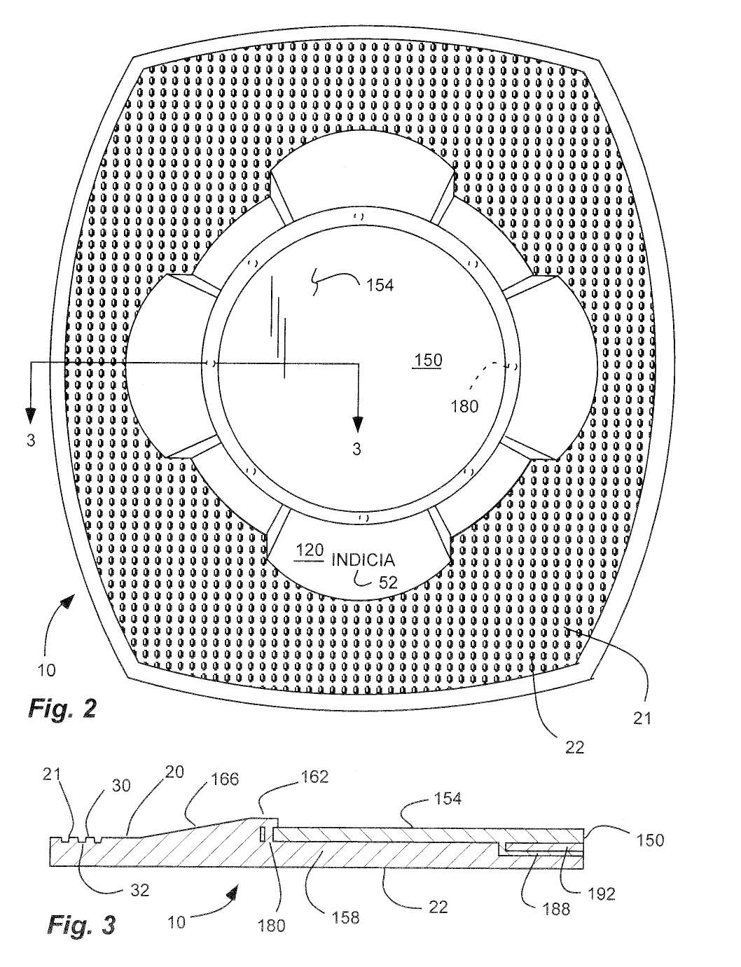

As illustrated in FIGS. 1-3, a frictional holding pad, indicated generally at 10, in accordance with the present invention is shown for releasably retaining, or selectively maintaining, a global positioning system (GPS) or GPS navigation system 12 on surface 16. The surface 16 can be planer or curved, and can include a dashboard or console of a vehicle. Securing a GPS in a vehicle is one field that may benefit from use of the present invention. In addition, the pad can releasably retain, or selectively maintain, another item 14 on the surface 16. The another item 14 can be any of a number of items, including for example, a cell phone, a personal digital assistant (PDA), a writing instrument, such as a pen or pencil, a pair of sunglasses, a pair of eye glasses, a global positioning system (GPS), a radio, a two-way radio, a citizens band (CB) radio, a walkie-talkie, a camera, a video recorder, a cassette player/recorder, a mini-cassette recorder, a DVD player, a mini-disk player, a portable television (TV), etc. It will be appreciated that other items can be selectively secured to the surface 16 by the pad 10. In addition, it will be appreciated that the pad can be disposed on other surfaces.

The frictional holding pad 10 has an upper surface 20 and a lower surface 22. The upper surface 20 can hold one or more objects 14 securely in place despite movement of the surface 16 or vehicle. The lower surface 22 is disposed on and grips the surface 16. The lower surface 22 of the frictional holding pad 10 can be “tacky”, such that the pad 10 tends to cling to the surface 16 in a mechanical fashion, as opposed to a chemical or adhesive manner. The lower surface 22 also can be smoother than the upper surface 20, or have a more shiny appearance.

In addition, the lower surface 22 can have a greater surface area in contact with the surface 16 to provide a greater frictional engagement. The upper surface 20 can have less surface area in contact with the object 14 to provide less frictional engagement. Thus, the pad 10 remains on the surface 16 when the object 14 is removed, rather than removing the pad from the surface while the object is removed from the pad. The upper surface 20 can have contours or texture (indicated at 21) formed thereon to reduce the surface area of the upper surface 20 in contact with the item 14 disposed thereon. Thus, the item 14 can be removed from the pad 10 without the pad sticking to the item or being removed from the surface 16.

The frictional holding pad 10 can be flexible and capable of bending to conform to curves or details in the surface 16. The frictional holding pad 10 also can have a planer configuration and can be used on planar surfaces. The frictional holding pad 10 can be provided in an original planar configuration, supported by a paper backing or release layer. The release layer prevents or resists the pad 10 or lower surface 22 from sticking or clinging to any wrapper or packaging of the pad. The release layer may be stiffer than the pad to maintain the pad in a planar configuration. In addition, the release layer can include indicia thereon, such as instructions for use and care of the pad. The release layer can include a tab protruding therefrom beyond a perimeter of the pad 10 to facilitate removal of the release layer from the pad. Upon removal of the release layer, the pad 10 is flexible to enable conformity with a wide array of curved surfaces. In addition, removal of the release layer exposes the lower surface 22 of the pad to be disposed on the surface 16. A removable wrapper can be formed around the pad 10 and the backing layer to protect the pad prior to use. The wrapper and backing layer can be removed prior to placing the pad on the surface 16.

The upper surface 20 of the pad 10 can be non-chemically adhered to items 14 placed thereon. Like the bottom surface 22, the upper surface 20 can be “tacky”, such that the pad 10 tends to cling to the item 14 in a mechanical fashion, as opposed to a chemical or adhesive manner. As stated above, the upper surface 20 can be contoured to include protrusions 30 and/or indentations 32. The protrusions 30 and indentations 32 can be rounded or curvilinear to form a more gradual transition between the protrusions and indentations, and create a contour on the upper surface 20 that is wavy or with a more natural appearance, creating a leather-like texture that can match the surface 16. The contour of the surface 20 creates an uppermost surface on the tops of the protrusions 30 that contacts the item 14. The upper or uppermost surface 20 thus has less surface area in contact with the item 14 than the lower surface 22 has in contact with the surface 16. Thus, a greater clinging force is exerted on the item 14 than on the surfaced 16 such that the item 14 can be removed from the pad 10 or upper surface 20 without removing the pad from the surface 16. In addition, the item 14 can be smaller than the pad itself, thus also contributing to less surface contact between the upper surface 20 and the item 14.

The contour, or protrusions or indentations, can extend at least substantially across the top of the pad. The contoured top surface defines an item receiving area where the item can be placed. The item receiving area thus extends at least substantially across the top of the pad. The contour can be disposed on a majority of the upper surface.

An array or matrix of a plurality of indentations 32 can be formed in the upper surface 20 of the pad 10 creating a plurality of protrusions 30 therebetween. The indentations 32 and protrusions 30 can be more straight, linear or recta-linear to create a more modern appearance.

The pad 10 can be formed of or can include an expanded vinyl material. It has been found that the expanded vinyl material provides a good frictional or “tacky” quality that remains disposed on the surface, and that retains the items thereon, In addition, it has been found that such an expanded vinyl material typically can be disposed on the surface 16 without marring or otherwise chemically interfering with the material of many surfaces, such as vehicle dashboards. It will be appreciated that many surfaces, such as a vehicle dashboard, have a finished surface configured to be aesthetically pleasing and luxurious. Such surfaces can be formed of a plastic or leather material, and can be expensive to replace or repair. In addition, it will be appreciated that some surfaces are subjected to extreme conditions, such as heat and sunlight. It has been found that the expanded vinyl material not only provides the required retention of objects and fixed relationship with the surface, but also typically does so without chemically interacting with the material of surface, or otherwise damage the surface.

The expanded vinyl material of the frictional holding pad 10 forms a temporary non-chemical bond with both 1) the items 14 stored on the upper surface 20, and 2) the surface 16. The pad 10 can be removed from the surface 16 without leaving behind any residue and without damaging the pad. In this manner the pad 10 can be easily moved to any location the user desires. Because the pad is made from expanded vinyl, it can be easily cleaned with soap and water, and still retain its tackiness, and is thus reusable.

The expanded vinyl material more specifically can include: diisodecy/phlthalate; polymeric plasticer; a UV stabilizer; a vinyl hear stabilizer; a blowing agent for vinyl plastisol; and vinyl resin (plastic). The expanded vinyl material can have a weight between approximately 10 and 20 ounces per square yard; more preferably between approximately 12 and 18 ounces per square yard; and most preferably between approximately 14 and 16 ounces per square yard. The frictional holding pad 10 can have a thickness between approximately 0.03 and 0.09; more preferably between approximately 0.04 and 0.08 inches; and most preferably between approximately 0.05 and 0.06 inches.

The frictional holding pad 10 can be formed of different layers with different materials. For example, the pad 10 can have a skin layer formed on the bottom surface 22 formed of a different material than the rest of the pad. For example, the material of the skin layer can include: aqua ammonia (NH₄OH); azardine; rubber; color; and body for thickening. The skin layer can have a thickness between 0.003 and 0.006 inches, and more preferably between 0.004 and 0.005 inches.

In addition, a perforated pattern can be formed in the pad 10 to give the impression of a stitching. For example, a plurality of holes can be formed around a perimeter of the pad near the edge to give the appearance of a stitched edge that can be more visually consistent with the surface 16. The pad 10 can be die cut from a larger sheet of material. The perforated pattern can similarly be formed by a die.

The frictional holding pad 10 also can include indicia 52 formed on the upper surface 20. The indicia 52 can be formed by ink, or ink-like materials, printed on the upper surface. The indicia 52 can include: a logo, an advertisement, an instruction, a promotion, a company name, and a product name. Thus, the frictional holding pad 10 can be used as a promotional item by including a business or product logo or name. It will be appreciated that such frictional holding pads can be inexpensively manufactured, and in use, can occupy a position of high and frequent visibility. Thus, such frictional holding pads can be inexpensively manufactured, and given away as promotional items. In addition, the indicia 52 can include instructions that can be related or unrelated to the use or care of the pad. For example, the instructions can include how to use or place the pad, and how to clean or wash the pad. As another example, the instructions can relate to the use of something other than the pad itself, such as an item to be disposed thereon. Thus, the pad serves dual functions, both as a frictional holding pad to secure and item, and providing ready instructions. The instructions can relate to the use of the item to be disposed thereon. Thus, such a pad can be provided with an item, or provided for use with such an item. For example, the instructions can relate to the use of a cellular phone. In addition, the indicia can include warning, such as warning not to drive while talking on the phone.

In addition, the pad can be translucent or transparent. Thus, surface details on the surface 16 can be viewed or are visible through the pad. The translucent or transparent nature of the pad can make the pad blend-in or match the surface 16 because of the surface details showing through the pad. If the pad is translucent, it can also include a light coloring. Such coloring can help visually distinguish the pad from the surface 16. Thus, a translucent pad can both blend with the surface while still being visually distinguishable therefrom.

In addition, the pad can be formed of, or can include, a translucent or transparent material. For example, the pad can include a molded polyurethane material. It has been found that the polyurethane material provides both a frictional or “tacky” quality that remains disposed on the surface, and that can be transparent or translucent. In addition, the polyurethane material can be easily cleaned with soap and water.

The indicia can be formed on the bottom surface of the pad and still be visible because the pad is translucent or transparent. Forming the indicia on the bottom surface of the pad can also protect the indicia from wear or removal.

The pad also can include a printable portion or section 120 that can include a substantially flat area on the upper surface 20. Thus, the upper surface 20 can be substantially contoured, but still have a flat printable portion or section 120 for indicia 52.

The pad preferably has a low profile, or is thin, having a thickness of less than approximately ⅛th of an inch. Thus, the items 14 are kept close to the surface 16 without extending where they might interfere with the operation of the vehicle.

Thus, the pad can be a thin sheet of polyurethane material with a substantially smooth and continuous lower surface 22 with a tacky characteristic to non-chemically and removably adhere to the surface 16, and a contoured upper surface 20 also with a tacky characteristic to non-chemically and removably adhere to an item. The pad or polyurethane material can be translucent or transparent, and can include printing on either the upper or lower surface.

The frictional holding pads described above can be sized and shaped to match the desired surface. For example, the pads can be sized to receive the above identified objects thereon, and to fit on typical dash boards. As an example, a size less than seven inches has been found to be useful. In addition, the pads can be sized or shaped to match other designs, such as logos.

A rigid plate 150 can be affixed to the flexible pad with an upper surface 154 of the plate exposed with respect to the pad. The upper surface 154 can be flat and smooth. The plate can be formed of plastic. A recess 158 can be formed in the pad and the rigid plate 150 can be disposed in the recess. A lip 162 can be formed around a perimeter of the recess and can enclose a perimeter of the rigid plate to help retain the plate in the recess. Thus the recess can be enlarged with respect to an opening to the recess defined by the lip, which can be annular. In addition, a raised annular flange 166 can extend upward from the pad to define the recess 158. And the raised annular flange 166 can enclose the perimeter of the plate.

A suction cup 170 can be coupled to the upper surface 154 of the rigid plate 150 by suction. The suction cup can be part of a GPS mount, as is known in the art. An arm 174 can extend from the suction cup, and thus with respect to the rigid plate. The GPS 14 can be mounted to the arm 174, such as by a ball and socket type connection so that the GPS is pivotal with respect to the arm, as is known in the art. In addition, the UPS can be removably mounted to the arm, such as with a press fit or C-shaped clamp, as is known in the art, so that the GPS is removably coupled to the pad and removably disposed over the pad.

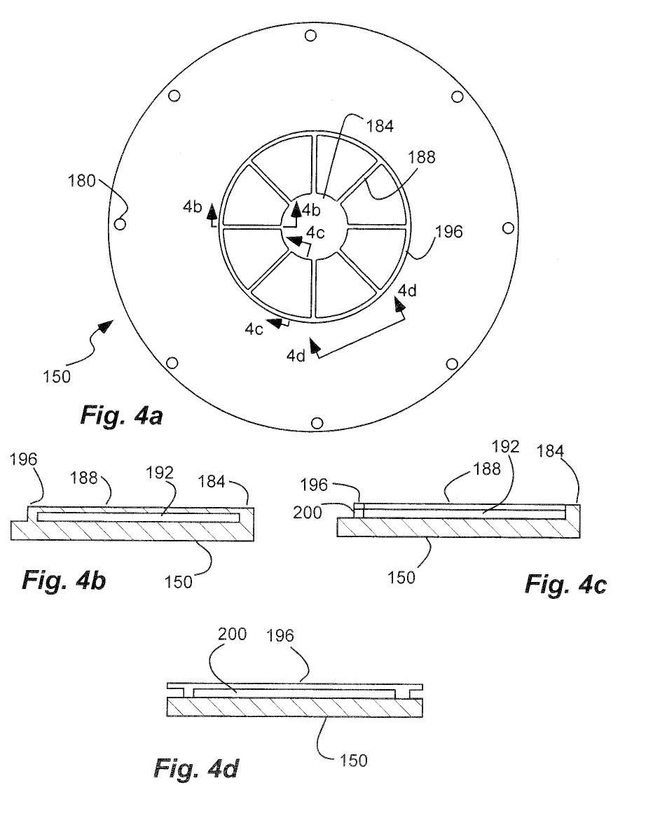

Referring to FIGS. 3-4d, the plate 150 can include structure to affix the plate to the flexible pad. A plurality of holes 180 can be formed in the plate, such as around the perimeter, to receive material of the pad. The holes 180 can be hidden by the lip 162 extending over the top of the plate. For example, polyurethane can be formed around the plate, and into the holes, during manufacture. In addition, a plurality of protrusions with apertures therein can extend from a bottom of the plate and into the pad material. The protrusions can include a wheel and/or spoke arrangement. A solid central hub or post 184 can extend from a bottom of the plate. A plurality of raised spokes 188 can extend radially from the hub. The spokes 188 can be raised from a bottom of the plate to create the apertures 192 between the bottom of the plate and the spokes to receive material of the pad. Similarly, a raised outer ring 196 can circumscribe the spokes. The ring 196 can have raised portions forming apertures 200 between the bottom of the plate and the ring to receive material of the pad. Again, polyurethane can be formed around the protrusions and into the apertures on the bottom of the plate during manufacture. It will be appreciated that the suction dup 170 can apply a great force to the plate. The structure on the bottom of the plate can assist in maintaining the flatness of the plate, and thus the suction, and maintaining the attachment of the plate to the pad. In addition, the plate has perimeter and interior attachments to the pad.

The frictional holding pad can also include a contoured bottom surface. The pad can have different top and bottom surfaces. The bottom surface can be substantially flat, as described above, to be disposed on the vehicle surface. Alternatively, the bottom surface can be contoured, as described below. The top surface can be different from the bottom surface and can include a contoured top surface to removably receive the item. At least a substantial portion of the top surface can be the contoured top surface. The contoured top surface can include a plurality of protrusions and/or indentations. The protrusions can extend from the top surface forming the indentations therebetween, or the indentations can extend into the top surface forming the protrusions therebetween. As discussed above, the contoured top surface can be formed by an array or matrix of indentations extending across a majority of the top surface.

Also as described above, the contoured top surface has an uppermost contact surface that is less than a lowermost contact surface the bottom surface. In addition, the contoured top surface can define an item receiving area that extends at least substantially across the top or top surface of the pad.

The bottom surface also can be contoured and can include a contoured bottom surface. The contoured bottom surface includes a plurality of protrusions and/or indentations. The protrusions and indentations of the bottom surface can be similar to those of the top surface, but can provide a lowermost contact surface to contact and frictionally cling to the vehicle surface. The lowermost contact surface of the bottom surface can have a greater surface area than the uppermost contact surface of the top. For example, the protrusions of the bottom surface can be larger than the protrusions of the upper surface. Or the indentations of the bottom surface can be larger than the indentations of the top surface.

The protrusions of the top or bottom surface can be substantially flat, or the uppermost and lowermost contact surfaces can be flat to maximize the surface area in contact with the vehicle surface or item.

A method for releasably securing a GPS on a dashboard or console of a vehicle surface without marring or altering the vehicle surface includes placing a frictional holding pad on the dashboard or console of the vehicle with a lowermost contact surface of the frictional holding pad contacting and frictionally clinging to the vehicle surface without marring or altering the dashboard or console of the vehicle. The GPS is secured over a contoured top surface of the frictional holding pad. The GPS can be removed from over the frictional holding pad while the frictional holding pad remains on the dashboard or console of the vehicle. The frictional holding pad can be removed from the dashboard or console of the vehicle without marring or altering the dashboard or console of the vehicle. The vehicle can be operated, moving the dashboard or console, with the GPS secured to and moving with the dashboard or console. In addition, the frictional holding pad can be bent to conform to changes in the dashboard or console. Furthermore, another item can be disposed on the frictional holding pad.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A frictional holding device in combination with a dashboard or console of a vehicle and receives and secures a global positioning system thereon, the combination comprising:
a) a dashboard or console of a vehicle;
b) a pad having different top and bottom surfaces, the bottom surface is disposed on and frictionally clings to the dashboard or console of the vehicle; and
c) a global positioning system removably coupled to the pad.

2. A device as in claim 1, further comprising:
a) at least a substantial portion of the top surface is a contoured top surface with a plurality of protrusions, a plurality of indentations, or both.

3. A device as in claim 1, further comprising:
a) at least a substantial portion of the top surface is a contoured top surface with an uppermost contact surface that is substantially flat with an array or matrix of indentations.

4. A device as in claim 1, further comprising:
a) another item, removably disposed on and frictionally clings to the top surface of the pad, the item is selected from the group consisting of: a cell phone, a personal digital assistant, a writing instrument, a pen, a pencil, sunglasses, eye glasses, a radio, a two-way radio, a citizens band radio, a walkie-talkie, a camera, a video recorder, a cassette player/recorder, a mini-cassette recorder, a DVD player, a mini-disk player, and a portable television.

5. A device as in claim 1, wherein the pad is formed of polyurethane.

6. A device as in claim 1, further comprising: indicia, formed on the top surface of the pad, the indicia being selected from the group consisting of: a logo, an advertisement, an instruction, a promotion, a company name, and a product name.

7. A device as in claim 1, further comprising: a removable backing layer, removably coupled to the bottom surface of the pad, prior to the pad being disposed on the dashboard or console of the vehicle.

8. A device as in claim 1, wherein the pad is bendable and includes a flexible material configured to conform the pad to changes in the vehicle surface.

9. A device as in claim 1, wherein the bottom surface of the pad is tacky; and wherein the top surface is less tacky than the bottom surface.

10. A device as in claim 1, further comprising an arm extending from the pad with the global positioning system coupled to the arm.

11. A method for releasably securing a global positioning system on a dashboard or console of a vehicle without marring or altering the dashboard or console of the vehicle, comprising:
a) placing a frictional holding pad on the dashboard or console of the vehicle with a bottom surface of the frictional holding pad contacting and frictionally clinging to the dashboard or console of the vehicle without marring or altering the dashboard or console of the vehicle;
b) securing a global positioning system over a contoured top surface of the frictional holding pad;
c) removing the global positioning system from over the frictional holding pad while the frictional holding pad remains on the dashboard or console of the vehicle; and
d) removing the frictional holding pad from the dashboard or console of the vehicle without marring or altering the dashboard or console of the vehicle.

12. The method of claim 11, further comprising:
a) disposing another item on and frictionally clinging to the top surface of the flexible pad selected from the group consisting of: a cell phone, a personal digital assistant, a writing instrument, a pen, a pencil, sunglasses, eye glasses, a radio, a two-way radio, a citizens band radio, a walkie-talkie, a camera, a video recorder, a cassette player/recorder, a mini-cassette recorder, a DVD player, a mini-disk player, and a portable television.

13. The method of claim 11, wherein placing the frictional holding pad on the dashboard or console of the vehicle further comprises: bending the frictional holding pad to conform the frictional folding pad to changes in the dashboard or console of the vehicle, the frictional holding pad including a flexible material.

14. The method of claim 11, further comprising: operating a vehicle such that the dashboard or console of the vehicle moves, with the global positioning system secured to and moving with the dashboard or console of the vehicle by the frictional holding pad.

15. A frictional holding device in combination with a dashboard or console of a vehicle and receives and secures a global positioning system thereon, the combination comprising:
a) a dashboard or console of a vehicle;
b) a flexible pad having different top and bottom surfaces, the bottom surface is disposed on and frictionally clings to the dashboard or console of the vehicle;
c) at least a substantial portion of the top surface is a contoured top surface with a plurality of protrusions, a plurality of indentations, or both;
d) a rigid plate affixed to the flexible pad with an upper surface of the plate exposed with respect to the flexible pad;
e) an arm extending from the rigid plate; and
f) a global positioning system coupled to the arm and removably disposed over the top surface of the pad.

16. A device as in claim 15, further comprising:
a) a suction cup coupled to the upper surface of the rigid plate by suction, with the arm coupled to the suction cup.

17. A device as in claim IS, further comprising:
a) a recess formed in the flexible pad;
b) the rigid plate disposed in the recess;
c) a lip formed around a perimeter of the recess and enclosing a perimeter of the rigid plate.

18. A device as in claim 15, further comprising:
a) a raised annular flange extending upward from the flexible pad and defining a recess;
b) the rigid plate disposed in the recess; and
c) the raised annular flange enclosing a perimeter of the rigid plate.

19. A device as in claim 15, further comprising:
a) at least one hole or aperture of the plate receiving a material of the flexible pad therethrough to assist in securing the plate to the flexible pad.

20. A device as in claim 15, further comprising:
a) another item, removably disposed on and frictionally clings to the top surface of the pad, the item is selected from the group consisting of: a cell phone, a personal digital assistant, a writing instrument, a pen, a pencil, sunglasses, eye glasses, a radio, a two-way radio, a citizens band radio, a walkie-talkie, a camera, a video recorder, a cassette player/recorder, a mini-cassette recorder, a DVD player, a mini-disk player, and a portable television

21. A device as in claim 15, wherein the pad is formed of polyurethane.

22. A device as in claim 15, further comprising: indicia, formed on the top surface of the pad, the indicia being selected from the group consisting of: a logo, an advertisement, an instruction, a promotion, a company name, and a product name.

23. A device as in claim 15, wherein the pad is bendable and includes a flexible material configured to conform the pad to changes in the vehicle surface.

24. A device as in claim 15, wherein the bottom surface of the pad is tacky; and wherein the top surface is less tacky than the bottom surface.
